(19) United States
(12) Patent Application Publication
(10) Pub. No.: US 2009/0178361 A1
(43) Pub. Date: Jul. 16, 2009

(54) METHOD OF FABRICATING FRAMES FOR 'DOORS AND THE LIKE FROM EXTRUDED COMPPONENTS AND REINFORCED FRAME OF EXTRUDED COMPONENTS

(76) Inventor: Kuei Yung Chen, Taipei (TW)

Correspondence Address: JOSEPH L. STRABALA, ESQ., ONE EMBARCADERO CENTER, SUITE 1020, SAN FRANCISCO, CA, 94111, US

(21) Appl. No.: 11/951,224

(22) Filed: Dec. 5, 2007

Related U.S. Application Data
(60) Provisional application No. 60/869,170, filed on Dec. 8, 2006.

(51) Int. Cl. E06B 1/04; B29C 47/06

(52) U.S. Cl. 52/656.2; 156/244.12

(57) ABSTRACT

Thermoplastic materials are now extruded with the final, desired cross sectional profiles and often have protective surfaces of a polyvinylchloride shell co-extruded on one or more than one of their outer surfaces. These profiles typically have hollow axial channels or cores running the length of the extrusion which applicant has found can be used to increase the rigidity of such profiles by inserting reinforcing members into such axial channels and fixedly securing the reinforcing member to the profile by mechanical fastening means and thereafter using such profiles to construct rectangular frames for windows, doors, casement and the like. The technique allows such reinforced profiles to be employed in frames where the mechanical loadings on such frames would otherwise prevent the use of such extruded profiles.

### BACKGROUND

It is known that wooden frames can be equipped [encased in part] with weather resistant surfaces by running the wooden components through a special extruder which places a weather resistant rigid polyvinylchloride shell on selected surfaces of the wood. An example of the latter is Andersen 400 series patio door which has an outer polyvinylchloride skin which is bonded to the exterior faces of the wooden components in an extruder of a special design which allows a wooden component to pass through the extruder as the skin or shell is applied to selected surfaces of the wooden component. With the described process, sometimes the shell or skin does not adhere well to the wood and delaminates. Moreover considerable milling of the wooden components in such frames is required before the skin or shell is applied, increasing the overall costs. Also problems result from insect or rot infestation of the wood and/or warpage when the frame is in place in use since the vinyl shell or skin does not increase stability of the wood component or provide complete encasement.

It is now possible to extrude thermoplastic components through dies which configure the extruded parts to the desired cross sectional shape and, like the process described above, apply a skin or shell to selected surfaces of the extruded part. Such components are fabricated in a co-extrusion process, see, e.g., U.S. Pat. No. 6,893,594 issued to Chen. Since both the extruded part and skin or shell are thermoplastic materials, during the co-extrusion process they readily bond together and subsequent de-lamination of the exterior shell is not a problem. Typically these extruded parts will have one or more hollow, continuous axial channels formed in the part, as the part is extruded from the die to improve the economy of such processes by reducing die amount of thermoplastic material required.

These extruded parts of compositions of thermoplastic materials closely adhere to the design specifications for the window, door or frame and provide attractive components for doors, windows and the like. However, such parts lack rigidity, especially in larger structures or structures having significant loading, on the extruded components, such as large glass. As result, extruded parts or components when employed for construction of frames such as those for sliding glass doors, may flex with the changes in building structures as wood dries, etc. leading to unsatisfactorily performance of frames, window and doors constructed with such extruded parts because of the significant loading. Thus the door or window structures with high unit loading may perform unsatisfactorily when such extruded parts are used to construct the rails and stiles of large window and or doors, or supporting frames for such structures.

It is an object of the current invention to make such extruded parts more serviceable by increasing their respective rigidity to enable the wider use of such extruded parts and enable more serviceable structures to be fabricated from them.

Further it is an object to provide serviceable door and window components more economically through extruded components that closely match the design specifications without further machining or milling.

Other objects and advantages will be apparent from the specification and drawings of this invention.

### SUMMARY OF THE INVENTION

An extruded component of a thermoplastic material having a co-extruded protective shell on at least one of its outer surfaces and such component having at least one continuous hollow channel running lengthwise of the component, the method of constructing doors, windows and the like from such extrusions includes the steps of inserting in the channel a longitudinal reinforcing member, fixedly securing the reinforcing member to the component by mechanical fastening means, and fabricating a building component by cutting the extruded components into selected lengths and joining such lengths into frames for doors, windows and the like, as well as casements for the same.

A door or window unit may include rails and stiles of four extruded component members, each having a hollow continuous channel running lengthwise of the member, reinforcing elements in each of such channels, mechanical fasteners passing through each member fixedly securing each reinforcing member in its associated channel with the ends of the members joined to form an integral rectangular reinforced structure for such a window or door or the like.

### DESCRIPTION OF THE DRAWINGS

FIG. 1 is a perspective of an extruded component according to this invention with a u-shaped reinforcing member partially inserted in a hollow channel in the component with screws for retaining it in the component exploded from their respective fastening openings;

FIG. 2 is a perspective of the extruded component shown in FIG. 1 wherein the u-shaped reinforcing member illustrated is secured in the component by the screws;

FIG. 3 is a perspective of a glass panel door with its rails and stiles constructed of lengths of the components shown in FIG. 1.

FIG. 4. is a perspective of the extruded component shown in FIG. 1 wherein two u-shaped reinforcing members are shown partially inserted in the hollow channels of the component and the screws for retaining these members exploded from the fastening openings;

FIG. 5 is a perspective of the extruded component shown in FIG. 3 wherein the u-shaped reinforcing members illustrated in FIG. 4 are secured in the component by the screws;

FIG. 6 is a perspective of an extruded component shown in FIG. 1 with a wooden reinforcing member partially inserted in a hollow channel in the component with screws for retaining it in the component exploded from their respective fastening openings;

FIG. 7 is a perspective of the extruded component shown in FIG. 1 wherein the wooden reinforcing member illustrated in FIG. 6 is secured in the component by the screws;

FIG. 8. is a perspective of the extruded component shown in FIG. 1 where in two wooden reinforcing members partially inserted in the hollow channels in the component and the screws for retaining these members exploded from their respective fastening openings;

FIG. 9 is a perspective of the extruded component shown in FIG. 8 wherein the two wooden reinforcing members illustrated in FIG. 8 are secured in the component by the screws;

FIG. 10 is a perspective of the extruded component shown in FIG. 1 wherein a wooden reinforcing members partially inserted in one of the hollow channels in the component and the screws for retaining these members exploded from their respective fastening openings on the perimeter of the component as a alternate way of mechanically securing the reinforcing;

FIG. 11 is a perspective of the extruded component shown in FIG. 1 wherein the wooden reinforcing member illustrated in FIG. 10 is secured in the component by the screws; and

FIG. 12 is a end view of a rail for a window with parts broken away and a stile in section illustrating a simple method for joining these reinforced parts with a lag bolt and plug exploded from the stile.

### DESCRIPTION OF AN EMBODIMENT

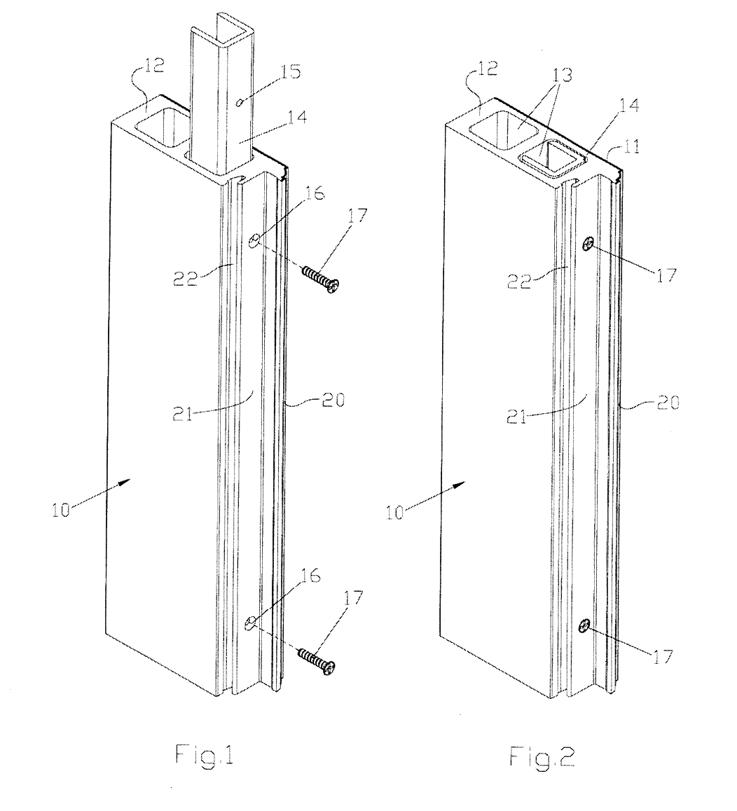

The component 10, shown in FIG. 1 et seq, can be can be formed from a thermoplastic composition or thermoplastic foam composition such as the composition described in U.S. Pat. No. 6,380,272 issued to Chen using an extrusion process. However the invention is not limited to a specific composition, but rather to compositions which can be extruded like the composition disclosed in the Chen patent. The plastic shell 11 is weather resistant polyvinylchloride which is co-extruded with the core 12 of the component; typically a shell forms the exterior surfaces of the extrusion that will be exposed to the weather. Being extruded, the component takes advantage of hollow core-designs which lessen its weight, such as continuous hollow channels 13 as shown in the Figures that run lengthwise of the extrusion. Also exterior surfaces of the component, which are not covered with the shell, can include wood imitation wood graining and can be painted or stained to coordinate with the interior of a room where a frame constructed of lengths of the component is located. Colors such as country white, Spanish oak, dark mahogany, or any other suitable color can be used to provide an initial color to the core's exterior surfaces not covered by the polyvinylchloride shell 11.

Referring to FIGS. 1, 4, 6, 8 and 10 each shows a reinforcing element partially inserted into one or more than one of the channels 13 in core 12 of component 10. More specifically in FIG. 1 a u-shaped reinforcing element 14, typically of steel or aluminum, is illustrated as partially inserted in one of the channels 13. This element has pre-drilled apertures 15 for screws which apertures can be tapped to provide threads if bolts are employed.

In the preferred embodiment the component 10 is drilled to provide screw holes 16 that register with the apertures 15 in the u-shaped reinforcing channel 14 when the latter is fully inserted as shown in FIG. 2. Screws 17 are used to mechanically secure the u-shaped reinforcing element 14 in its channel to provide its final rigidity. Or course the gage of the reinforcing element is chosen to obtain the desired rigidity.

In FIG. 2. the unshaped reinforcing 14 is shown fully inserted in channel 13 of core 12 and is mechanically fastened therein with screws 17. Hollow channels 13 are smooth and uniform as during the extrusion process of the component 10 the channels are held to a desired cross sectional dimension by the die configuration and cooling techniques.

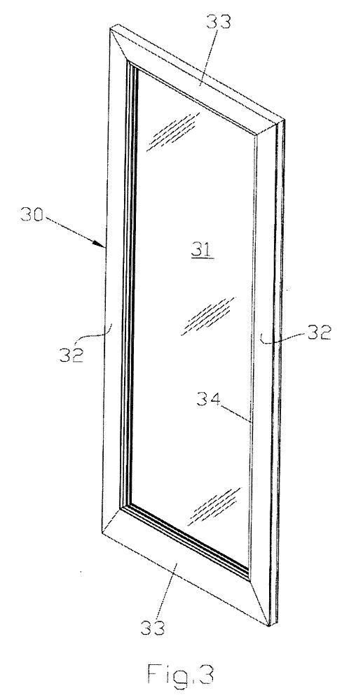

Component 10 shown in the drawings can be used for fabricating the rails and stiles of a glass panel door 30, see FIG. 3, and is configured with a raised rib 20 along one face that forms part of the glazing structure for the glass panel 31 that is inserted when four separate sections of the component are connected to form a rectangular frame for a glass door consisting of stiles 32 and rails 33. As part of the glazing structure a base 21 is formed adjacent to the inside bottom of the rib and on the side of the component, opposite the rib, a configured groove 22 is provided for the glazing bead 34 of the glazing structure which can be snapped in place after the glass panel is inserted. Typically the holes 16 for the screws 17 are drilled in the base of the glazing structure and will be invisible when the door unit is complete. In FIG. 3 the the rails and stiles are connected in a miter joint, which can include a right angle fitting (not shown) that engages the u-shaped reinforcing element 14 in the rails and stiles to create a fully integrated rectangular reinforcing structure within these extruded parts. Other means of interconnecting the ends of the reinforcing elements to form integrated internal reinforcing structure is within the contemplation of this invention.

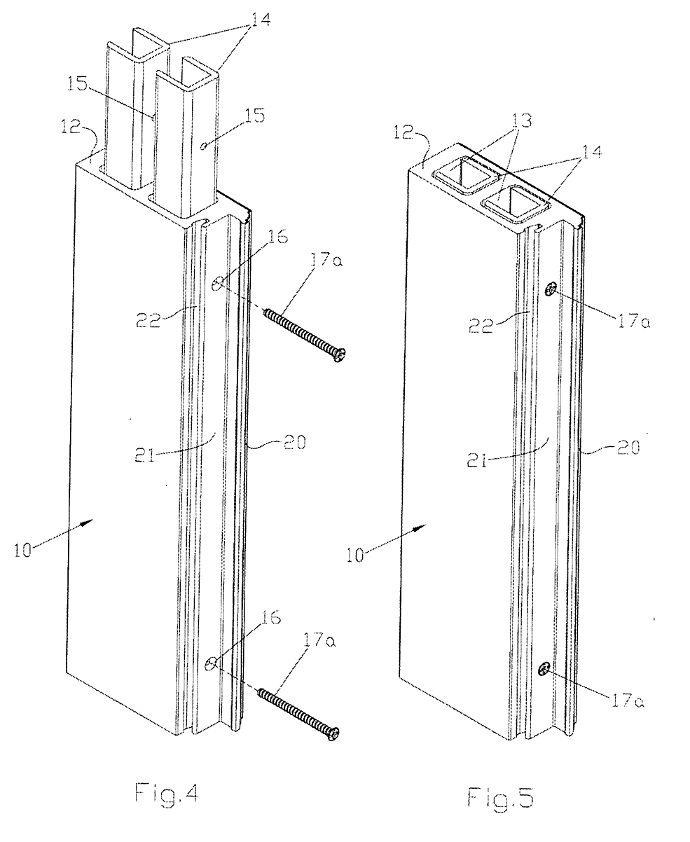

In FIG. 4 two unshaped reinforcing elements 14, one in each channel, are employed in channels 13. Using double reinforcing enables the rails and stiles of door or window constructed with sections of the component 10 to withstand much higher loadings without any distortion. In this embodiment, the screws 17a are longer so that they will engage both of the reinforcing elements when inserted as shown in FIG. 5.

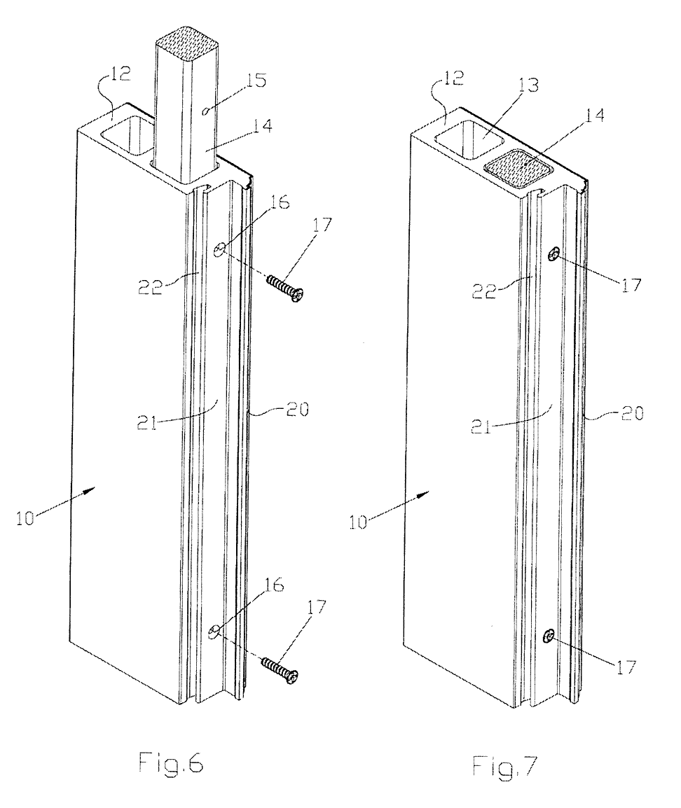

While the earlier Figures illustrated metal reinforcing elements 14, FIGS. 6 and 7 illustrate a wooden reinforcing element inserted in one of the channels 13 of the core 12 of the component 10. This reinforcing element is shown secured in the component with screws in FIG. 7.

While the embodiment in FIG. 6 is excellent for smaller windows, double wooden reinforcing elements used in component 10, as shown in FIGS. 8 and 9, are more suitable for larger windows and doors when using wood reinforcing elements. Because two separate reinforcing elements are employed longer screws 17b are necessary to positively secure both elements in the component, as shown in FIG. 9.

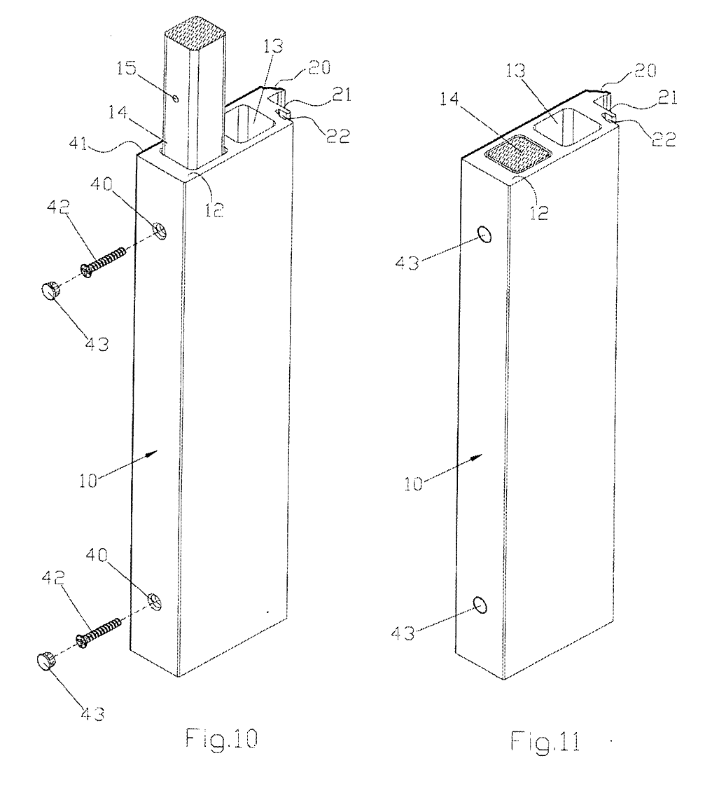

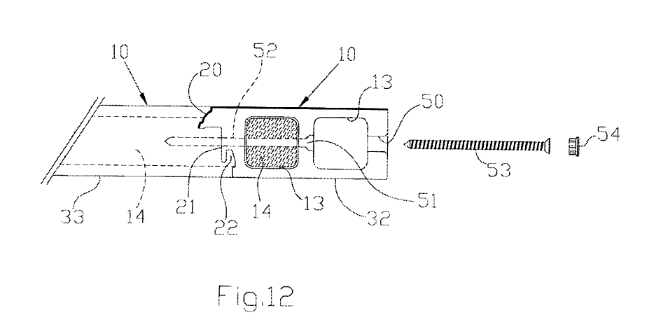

Earlier embodiments of the invention placed the screws 17 in the base 21 of the glazing structure making them invisible when a door or window is completed. An alternated method of attaching the reinforcing element 14 is shown in FIGS. 10 and 11 where holes 40 are provide in the perimeter edges 41 of the component 10. As before, the reinforcing is fully inserted and then is mechanically secured by screws 42 inserted from the perimeter of the component as shown in FIG. 11. These screws are counter sunk so after they secure the reinforcing element, plugs 43 can be inserted to hide the screw heads and create smooth exterior perimeter.

One method of producing an integral rectangular frame according to the current invention is to cut the extruded component 10 in the desired lengths for the rails and stiles of a door or window with the appropriate miters at the ends and then add the reinforcing elements 14 with matching miters, followed by securing one or more than one reinforcing elements in the several rails and stiles to one another. Various joint systems can be utilized to join these reinforcing elements when the ends of the members forming the rails and stiles are glued together or otherwise attached to make a frame or a casement.

It has been found that the spacing of the screws 17, 17a and 17b should be at least 4 inches apart for the best performance of the resulting door or window.

While utilizing the reinforcing elements 14 in door and window rails and stiles or the like is the most advantageous use of the invention, these reinforcing elements can be utilized to reinforce extruded casements of sliding glass doors as well, where it is necessary to maintain rigidity of the bottom track so it is not distorted by movements in the building structure.

A very economical construction is shown in FIG. 12 using the reinforced components 10 for window and door construction. In this figure the stile 32 is provided with an outer aperture 50 and an inner aperture 51 through which apertures the wooden reinforcing element 14 can be accessed. A pilot hole 52 is drilled though this reinforcing element and into the end of the corresponding reinforcing element 14 (shown in phantom) in rail 33. The end of this rail is milled to fit into the inner face of the stile, with the rib 20 functioning like a tendon and when lag 53 is screwed into the pilot bore it will draw the rail and stile together at this joint which will typically include a glue at the interface. The outer aperture 50 is subsequently closed by a plug 54. It can be appreciated that the opening of the channels 13 in the top and bottom of the stile can also be fitted with plugs if desired or a flat finishing strip can be glued on the top and bottom of the door or window to cover these opening.

Using this means of connection of rails and stiles enables easy fabrication of different size doors and windows as only a minor amount of milling is required on the ends of the rails or alternatively the stiles to build the frames as the other parts of the frames are completely formed by the extrusion process, complete with the polyvinylchloride shell 11.

Having described my invention, I claim:

1. A method of constructing a frame for a door, window of the like comprising the steps of:
extruding a component of thermoplastic material having a cross-section desired for the frame while simultaneously co-extruded a polyvinylchloride protective shell on at least one of the outer surface of said component with said component being extruded with at least one hollow axial channel;
inserting a reinforcing member in such axial channel;
fixedly securing said reinforcing member in such axial channel; and
fabricating a frame with a plurality of said components by joining them in a rectangular frame.

2. The method defined in claim 1 wherein the reinforcing member is a metal member.

3. The method defined in claim 1 wherein the reinforcing member is a wooden member.

4. The method defined in claim 1 wherein the component includes two hollow axial channels and a reinforcing member is inserted into each such channel and fixedly secured therein.

5. A method of constructing a frame for a door, window of the like comprising the steps of
extruding a component of thermoplastic material having a cross-section desired for the frame while simultaneously co-extruded a polyvinylchloride protective shell on at least one of the outer surface of said component with said component being extruded with at least one hollow axial channel;
inserting a reinforcing member in such axial channel;
fixedly securing said reinforcing member in such axial channel;
cutting said component into selected lengths, and
fabricating a frame with said selected lengths by joining them in a rectangular frame.

6. The method defined in claim 5 wherein the reinforcing member is a metal member.

7. The method defined in claim 5 wherein the reinforcing member is a wooden member.

8. A frame for a door window or casement comprising:
a plurality of extruded thermoplastic components having the desired cross sectional configuration for the desired frame created by the extrusion die and a protective polyvinylchloride shell co-extruded on at least one of their outer surfaces, each of said components having an axial hollow axial channel formed therein when extruded;
each component having a reinforcing member inserted into its axial hollow channel and fixedly secured therein; and
a rectangular frame constructed by joining the respective ends of said components to fabricate the same.

9. The frame defined in claim 8 wherein the reinforcing member is a metal member.

10. The frame defined in claim 8 wherein the reinforcing member is a wooden member.
